(19) United States
(12) Patent Application Publication
(10) Pub. No.: US 2013/0239191 A1
(43) Pub. Date: Sep. 12, 2013

(54) BIOMETRIC AUTHENTICATION

(71) Applicant: James H. Bostick, Tucson, AZ (US)

(72) Inventor: James H. Bostick, Tucson, AZ (US)

(21) Appl. No.: 13/417,127

(22) Filed: Mar. 9, 2012

(51) Int. Cl. G06F 21/20; G06F 7/04

(52) U.S. Cl. 726/7

(57) ABSTRACT

This document discusses, among other things, apparatus and methods for providing persistent biometric authentication for a computer system. In an example, a method can include collecting behavioral interaction information associated with a user account on the computer system, comparing the behavioral interaction information with a behavioral model associated with the user account; and adjusting an authentication confidence metric based on the comparison.

### TECHNICAL FIELD

Embodiments relate to computer system security and more particularly to persistent biometric authentication of access to a computer system.

### BACKGROUND

Electronic information has allowed users to be more mobile and the content of the information to be passed quickly and efficiently. As new formats and protocols to store display and transfer the information have been developed so to have new methods of protecting electronic information. However, existing security systems authenticate access to information at one or more discrete points in time (e.g., “snap-shot” authentication) and use that authentication to allow minimally supervised access to the information for lengthy periods of time thereafter.

### SUMMARY

This document discusses, among other things, apparatus and methods for providing persistent biometric authentication for a computer system. In an example, a method can include collecting behavioral interaction information associated with a user account on the computer system, comparing the behavioral interaction information with a behavioral model associated with the user account; and adjusting an authentication confidence metric based on the comparison.

This summary is intended to provide an overview of subject matter of the present patent application. It is not intended to provide an exclusive or exhaustive explanation of the invention. The detailed description is included to provide further information about the present patent application

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally an example physical, virtual, or networked computer system including a persistent biometric authentication security system.

FIG. 2 illustrates generally an example method of providing persistent biometric authentication.

FIG. 3 illustrates generally how strongly an authenticated user's current behavior matches their behavioral model over time.

FIG. 4 illustrates example confidence level information associated and an example confidence threshold plotted over time.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Existing user account authentication systems attempt to ensure that the identity of the user using a particular account on a physical, virtual, or networked computer system is the user originally associated with the account. Such authentication is used for multiple purposes. In certain examples, a computer system can be a single electronic device such as, but not limited to, a laptop computer, a desktop computer, a cell phone, or a tablet computer, for example. In certain examples, a computer system can include a plurality of networked electronic devices that may or may not include one or more servers. First, it allows for access control to the computer, the network, and other resources and, in turn, access control to information stored on the physical, virtual, or networked computer system. In such a scenario, a user can be trained in the preferred methods of using the physical, virtual, or networked computer system including proper and improper means of accessing information on the physical, virtual, or networked computer system as well as proper and improper methods of using the information stored on the physical, virtual, or networked computer system. After training, a user account on the computer network can be created. The user account can include access information such that the user can be allowed or denied access to information available on the network according the access information. In many physical, virtual, or networked computer systems, a username and password are associated with the user and are used to access the physical, virtual, or networked computer system, or access an application that can access the physical, virtual, or networked computer system, via the user account. In some situations, a biological marker of the user, such as but not limited to, a biological marker derived from a fingerprint or retinal scan, for example, can be associated with the user account. Upon accessing the physical, virtual, or networked computer system or an application that can access the physical, virtual, or networked computer system, a user can be prompted to provide their fingerprint or a retinal scan to authenticate the user with the user account and to permit access to the physical, virtual, or networked computer system and the information available through the physical, virtual, or networked computer system. Once authenticated, the user account can access any and all the information allowed via the access information associated with the user account.

A very insidious risk for any entity that maintains valuable information accessible on a physical, virtual, or networked computer system is the risk of exploitation of that valuable information from an insider threat, such as a user that has been vetted and placed in a position of trust, and granted legitimate access to the physical, virtual, or networked computer system. “Snapshot” authentication methods, such as one-time login sequences, can offer occasional protection but do not continuously monitor the account activities of each user account. Existing defense strategies employing authentication mechanisms for logical access leave holes that can be exploited by sophisticated attackers. For instance, password and password-based systems are call-response techniques, meaning they authenticate only at a specific moment. A malicious threat can pass one or more call-response checkpoints to receive permission to proceed with further nefarious activities. In single sign-on systems, this is especially disastrous since access to one system can automatically grant uninterrupted, widespread access to a network of other systems. A threat can easily steal, spoof, guess, or brute-force these checkpoints to ex-filtrate data and compromise systems. Multi-factor authentication mechanisms only marginally increase safety as they, like passwords, can be overcome by similar techniques.

The present inventor has recognized apparatus and methods for defending high-risk information technology systems by continuously comparing user account interactions with unique user identity models using persistent biometric behavior authentication. In some contexts, a user may be an individual person or a group of people such as a department of users, for example. In certain examples, a persistent biometric authentication system can integrate and complement existing authentication protocols, such as “snapshot” authentication protocols, and can be transparent to users. In some examples, a persistent biometric authentication system can provide real-time preventative and real-time attack protection. Threats that the persistent biometric authentication system can identify, track or assist in identifying a user account used to perpetrate the attack, can take many forms, such as, but not limited to, viruses, rogue users, keyloggers, etc. In certain examples, a persistent biometric authentication system can use real time behavioral analyses to detect and deter authentication breaches of a physical, virtual, or networked computer system. The real-time behavioral analyses can interpret continuous biometric expressions inherent to each user to distinguish between legitimate users accessing the physical, virtual, or networked computer system via their user account and a rouge user hijacking the system or using a legitimate user account in a manner that is inconsistent with a biometric behavioral profile associated with the user account. A persistent biometric authentication system can reduce the burden of defense against attacks from the user in certain examples. In some examples, a persistent biometric authentication system can track numerous attack threats simultaneously and transparently.

In certain examples, the persistent biometric authentication system can use multi-model behavioral models and real time statistical interpretation to evaluate a threat level of one or more user accounts. In some examples, the persistent biometric authentication system can use one or more input channels to evaluate behavioral biometrics of a user account including, but not limited to, mouse kinematics, keystroke kinematics, application interaction behavior, network traffic activity, or combinations thereof.

Existing authentication and security methods can provide a level of security that can protect valuable information available to a user account from being used in a manner that can hurt the value of the information owner or diminish the value of the information to the owner of the information. However, much of that security depends on the loyalty of user associated with the user account as well as the responsible use of the user account by the user. For example, once a user account is authenticated, even the account of a loyal user, a person or entity other than the user can use the user account to breach security of the information to which the account has access if the user or some other mechanism does not monitor the use of the user account after authentication. Such scenarios are possible when a user fails to log out of a physical, virtual, or networked computer system or leaves a work station without logging out of a physical, virtual, or networked computer system.

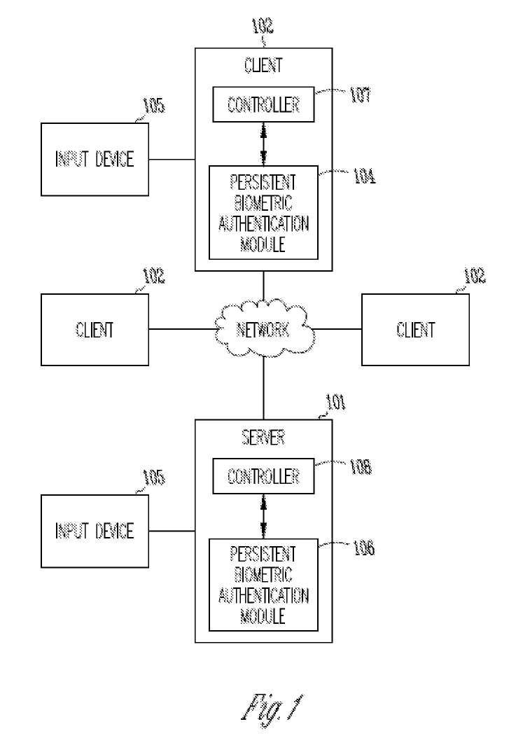

FIG. 1 illustrates generally an example physical, virtual, or networked computer system 100 including a persistent biometric authentication security system. The physical, virtual, or networked computer system 100 can include one or more servers 101, one or more clients 102 and a network 103 to link the one or more servers, to link the one or more clients, and to link the one or more servers and the one or more clients. It is understood that the physical, virtual, or networked computer system can include both wired and wireless communication capabilities without departing from the scope of the present subject matter. In certain examples, users of the physical, virtual, or networked computer system 100 are provided a user account to access one or more portions of the physical, virtual, or networked computer system 100. A user generally can sign into a user account of the physical, virtual, or networked computer system 100 and gain access as permitted by parameters of the user account. In certain examples, a persistent biometric authentication module 104, 106 of a persistent biometric authentication system can collect biometric behavioral information related to the interaction of the user account with the physical, virtual, or networked computer system 100, such as interactions with input devices 105, interactions with output devices, interactions with applications, interactions with communications over the network, etc. In some examples, upon first implementing the persistent biometric authentication system, one or more persistent biometric authentication modules 104, 106 can process the biometric behavioral information to form a model associated with one or more user accounts. A model may also be called a signature profile. In certain examples, models can be associated with an individual user account, with a group of one or more user accounts, a server, a location such as a building or a sub-location, etc.

In certain examples, the persistent biometric authentication system can include one or more authentication confidence metrics. In certain examples, an authentication confidence metric can be associated with a user account. In some examples, an authentication confidence metric can be associated with a group of user accounts. In an example, the physical, virtual, or networked computer system 100 can have an associated authentication confidence metric. In some examples, a location can have a composite authentication confidence metric.

In certain examples, the server can manage user accounts and models, and the client can analyze real-time behavioral biometrics and monitor for inconsistent behaviors using adaptive filters to compare various temporal, qualitative and quantitative patterns or thresholds with the models.

In certain examples, a threat condition index can be used to adjust one or more authentication confidence metrics. A threat condition index can provide an indication of the probability that an associated entity, such as an associated user account, is a threat to the security of the physical, virtual, or networked computer system 100. In some examples, such as a threat condition index associated with the entire physical, virtual, or networked computer system 100, the threat condition index can provide an indication of the probability that the associated entity will be threatened. For example, if a system wide threat, such as a virus, has been identified, but a solution has not been provided, the threat condition index for the physical, virtual, or networked computer system 100 can be adjusted to indicate a more likely probability of a security breach. In another example, such as when a virus or worm has been identified that is predicted to execute on a certain day or during a certain time interval, the threat condition index can be use to adjust the authentication confidence metric of all or a plurality of user accounts that may be susceptible to the threat. In response to the adjustment of the threat condition index associated with the physical, virtual, or networked computer system 100, smaller deviations between recently collected biometric behavior information and biometric models can trigger actions to defend against a possible security breach of the physical, virtual, or networked computer system 100 or to defend against on on-going security breach of the physical, virtual, or networked computer system 100.

In some examples, a general threat can be identified and associated with a certain location or combination of locations, but a specific user account or cause of the threat may not be identified. An authentication confidence metric associated with the locations can be adjusted such that biometric information, including behavioral interaction information, collected from user accounts logged in from the certain locations can be evaluated under more stringent thresholds. Operating under more stringent thresholds can include taking defensive actions to prevent or mitigate a threat when analyses of collected biometric information compared with a model includes smaller deviations than prior to adjusting the authentication confidence metric.

In certain examples, defensive action to prevent or mitigate an attack can include limiting access to system resources when collected biometric information deviates from a model by at least a threshold amount. An authentication confidence metric can be used to adjust the threshold amount. For example, if a user account includes a security index that indicates the account is of little risk of causing or participating in actions that threatened the security of the system or information stored on the system, the threshold amount can be at a maximum. In certain examples, when the threshold amount is at a maximum, the persistent biometric authentication system can collect and analyze biometric information to train a model associated with the user account.

A model can include behavioral interaction information such as temporal, qualitative and quantitative information associated with one or more user accounts. In certain examples, the temporal, qualitative and quantitative information can be associated with one or more user inputs to the physical, virtual, or networked computer system 100 such as one or more keystrokes, movement and interaction with a pointing device input, interaction with a communication port such as a USB port, or selection and use of one or more applications. In some examples, the one or more user inputs can be associated with a user account of the physical, virtual, or networked computer system 100. In certain examples, behavioral interaction information can include information associated with network traffic initiated by one or more user accounts or applications associated with one or more accounts.

In certain examples, upon detecting that collected biometric information, such as behavioral interaction information, exceeds an allowable threshold, an authentication confidence metric can be adjusted. In certain examples, upon detecting that collected biometric information, such as behavioral interaction information, exceeds an allowable threshold, an authentication confidence metric can be adjusted, and either a client-located persistent biometric authentication module 104 or a server-located persistent biometric authentication module 106 can provide an alert to a controller 107, 108 of the system. In certain examples, the alert can take the form of a notification message to an administrator of the system, an e-mail to one or more system users, or other automated action to prevent or reduce a breach of the physical, virtual, or networked computer system 100, the information stored on the physical, virtual, or networked computer system 100 or applications available on the physical, virtual, or networked computer system 100. For new user accounts, thresholds can be used that allow a statistically significant model to be built without significantly interrupting the user account activity. Such thresholds can allow significant change in biometric behavioral metrics without disabling the user account activity. As the user account expresses statistically significant activity the thresholds can be modified to evaluate the user account under more stringent threshold conditions. In certain examples, as behavior of a user changes over time due to age, medical or other condition, the user account model and associated thresholds can also change as trends due to such conditions are evaluated via the collected biometric behavioral information.

In certain examples, the controller 107, 108 can notify an administrator of the physical, virtual, or networked computer system 100 in response to the alert. In an example, access to one or more portions of the system can be revoked for one or more user accounts by the controller 107, 108 in response to an alert. In some examples, a portion of the physical, virtual, or networked computer system 100 can include information stored on the physical, virtual, or networked computer system 100, an application available on the physical, virtual, or networked computer system 100, subsystems of the physical, virtual, or networked computer system 100, or functions of an application available on the physical, virtual, or networked computer system 100. In certain examples, a controller 107, 108 can revoke all access to the physical, virtual, or networked computer system 100 by one or more user accounts in response to an alert. In certain examples, the persistent biometric authentication system can adjust an authentication confidence metric when the collected biometric information associated with a user account or a plurality of user accounts conform to a model for a predetermined or dynamically evaluated interval of time. Such an adjustment can indicate a higher level of confidence that the associated user accounts do not pose a threat to the physical, virtual, or networked computer system, or the information or applications stored on the physical, virtual, or networked computer system.

In certain examples, a client-located persistent biometric authentication module 104 can perform analyses of a single user account using the client. In certain examples, a server located persistent biometric authentication module can perform analyses across one or more groups of user accounts. In some examples, the analyses can include probability correlation mathematics. In certain examples, the system can be implemented on a hybrid peer-to-peer/client server architecture.

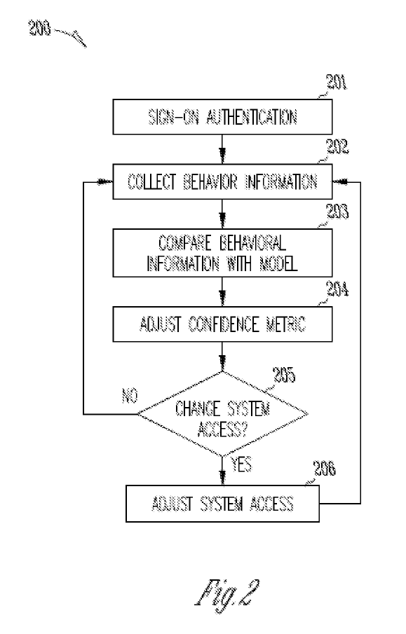

FIG. 2 illustrates generally an example method 200 of providing persistent biometric authentication. At 201, the method can include authenticating access for a user account to a computer system. In certain examples, the authenticating access can include a one-time sign-on using a user name and a password. In an example, the authenticating access can include receiving an electronic representation of a biometric marker of a user such as a retina scan, fingerprint facial recognition sample, etc. At 202, the method 200 can include collecting behavioral interaction information associated with the user account. In certain examples, the collecting behavioral interaction information can include collecting temporal, qualitative and quantitative information associated with one or more user inputs to the computer system. Such inputs can include, but are not limited to, keystrokes, pointer movements and actuations such as from a mouse or finger pad, or insertion, activation, gestures traced on a touch screen or tablet, device movements received using an accelerometer, inertial, or other orientation sensor of the device, and removal of accessory devices such as USB accessory devices. In certain examples, temporal, qualitative and quantitative information can include selection and movement between applications, and user activities within an application. In some examples, user activities within an application can include, but are not limited to, movement when creating and reviewing a document within a word processing application, or creating, moving within, and entering data within a spreadsheet application. At 203, the method can include comparing the behavioral interaction information with a behavioral model associated with the user account. In certain examples, the comparing the behavioral interaction information with a behavioral model can include comparing deviations between the model and the collected biometric behavioral information with a threshold. At 204, the method can include adjusting an authentication confidence metric using the comparison. In certain examples, the method can include receiving an authentication confidence metric indicative of a threat condition a group of user accounts, a location associated with the physical, virtual, or networked computer system, of the overall physical, virtual, or networked computer system. In an example, the method can include, or the adjusting the authentication confidence metric can include, receiving a threat condition index, and adjusting the authentication security index using the threat condition index.

In certain examples, at 205 the authentication confidence metric for one or more user accounts can be compared to threshold to determine of access to the computer system should be changed or if a controller of the computer system should provide an alert to draw attention to a potential threat to the system. In certain examples, at 206, the computer system can automatically respond to the alert by adjusting access to the computer system by the one or more user accounts. In an example, a controller of the system can provide one or more e-mails containing detailed information about the alert, such as identifying the one or more users, or the activities leading to the alert. It is understood that other action may be taken to prevent an attack on the computer system or to mitigate an attack on the computer system without departing from the scope of the present subject matter. Such action can include, but are not limited to, revoking user account access to portions of the computer system including resources and information available using the computer system.

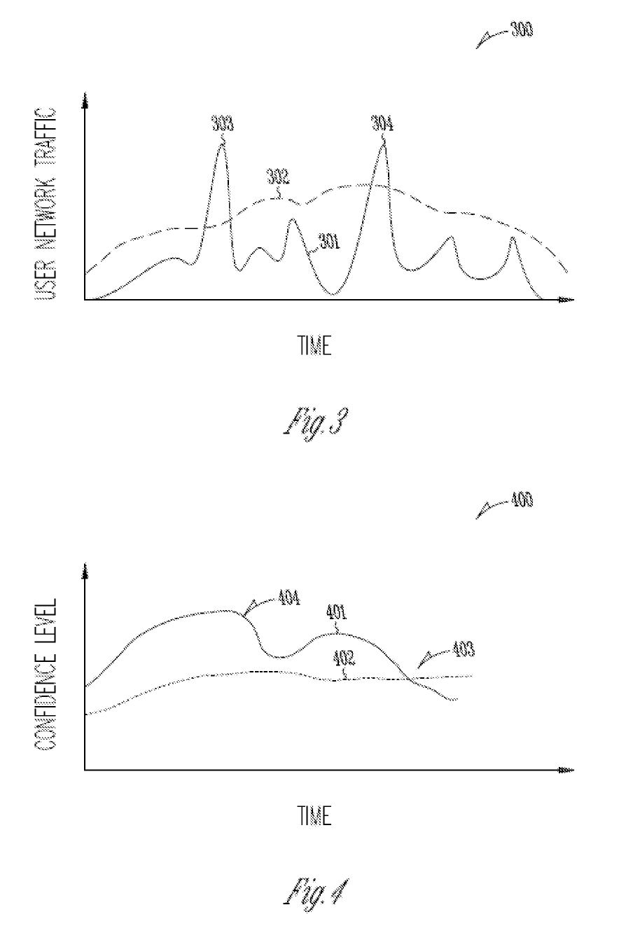

FIG. 3 illustrates generally a graphic comparison 300 of collected biometric behavioral information 301 and a model 302 associated with a user account. The model 302 can illustrate expected or anticipated values of biometric behavior information associated with the user account. The collected biometric behavioral information 301 can include, but is not limited to, average keystroke frequency over a period of time, temporal or frequency related pointing device interactions, application interactions, user initiated network traffic, or combinations thereof. In an example, the collected biometric information 301 can be average network data rates initiated by a user account over a period of time. It is understood that collecting and comparing other biometric interaction behavior information associated with one or more user accounts of a computer system are possible without departing from the scope of the present subject matter. The graphic comparison 300 includes two peaks 303, 304 that extend outside the model limit. In certain examples, upon detection of behavior associated with the biometric behavior information extending outside a model limit, an authentication confidence metric associated with the user account can be adjusted. The adjustment can be in a manner to indicate the activity associated with the user account may pose an increased threat to the computer system. During times when the activity associated with the user account remains within the expected model, the authentication confidence metric associated with the user account can be adjusted in a manner that indicates the activity associated with the user account may pose a decreased threat to the computer system. If the authentication confidence metric satisfies a certain threshold of risk, additional action, such as that discussed above, can be executed to prevent a potential attack associated with the user account or to limit an attack identified with the user account.

In the example of FIG. 3, the threshold can represent a maximum threshold. It is understood that other biometric behavior information can be evaluated against a minimum threshold or can be evaluated against a threshold that includes both a minimum threshold and a maximum threshold without departing from the scope of the present subject matter. In certain examples, the threshold can be dynamic in that as the model associated with the user account or group of user accounts is updated, the corresponding thresholds can be updated.

FIG. 4 illustrates example confidence level information 401 associated with a user account or group of user accounts and an example confidence threshold 402 plotted over time. The confidence level information 401 can vary as the user account activities are monitored, collected and analyzed by an example persistent biometric authentication system. Where the confident level information falls below 403 the confidence threshold, the persistent biometric authentication system can generate an alarm or take action to prevent a possible attack to the physical, virtual, or networked computer system via the user account or to prevent further on-going illicit activity via the user account.

In certain examples, additional checks of a user account or group of user accounts can be analyzed. In an example, change in confidence level of the confidence level information can be evaluated with respect to a change in confidence level threshold. This type of analysis can be useful in detecting when a user account has been used by someone other than the modeled user. For example, the confidence level information of FIG. 4 shows a large change in confidence at the area labeled 404. Such a change can be an indication that the user account has been used by someone other than the user upon which the confidence model has been developed. If such a change in confident level exceeds a threshold, the persistent biometric authentication system can generate an alarm or take action to prevent a possible attack to the physical, virtual, or networked computer system via the user account or to prevent further on-going illicit activity via the user account.

### Additional Notes

In Example 1, a method for persistent authentication using biometric behavioral analyses can include authenticating access for a user account to a physical, virtual, or networked computer system, collecting behavioral interaction information associated with the user account, comparing the behavioral interaction information with a behavioral model associated with the user account, and adjusting an authentication confidence metric using the comparison.

In Example 2, the collecting behavioral interaction information of Example 1 optionally includes collecting temporal, qualitative and quantitative information associated with one or more user inputs to the physical, virtual, or networked computer system.

In Example 3, the collecting temporal, qualitative and quantitative information associated with one or more user inputs to the physical, virtual, or networked computer system of any one or more of Examples 1-2 optionally includes receiving one or more keystrokes at the physical, virtual, or networked computer system.

In Example 4, the collecting temporal, qualitative and quantitative information associated with one or more user inputs to the physical, virtual, or networked computer system of any one or more of Examples 1-3 optionally includes receiving signals from a pointing device.

In Example 5, the collecting behavioral interaction information of any one or more of Examples 1-4 optionally includes collecting temporal, qualitative, and quantitative user interaction information associated with interactions between the user and an application configured to operate on the physical, virtual, or networked computer system.

In Example 6, the collecting behavioral interaction information of any one or more of Examples 1-5 optionally includes collecting temporal, qualitative, and quantitative network traffic information associated with one or more user inputs to the physical, virtual, or networked computer system.

In Example 7, the method of any one or more of Examples 1-6 optionally includes providing an alert if the authentication confidence metric satisfies a threshold.

In Example 8, the providing an alert of any one or more of Examples 1-7 optionally includes restricting access to the physical, virtual, or networked computer system via the user account.

In Example 9, the collecting behavioral interaction information of any one or more of Examples 1-8 optionally includes collecting first behavioral interaction information associated with the user account, and generating the behavioral model associated with the user account using the first behavioral interaction information.

In Example 10, the collecting behavioral interaction information of any one or more of Examples 1-9 optionally includes collecting second behavioral interaction information associated with the user account different from the first behavioral interaction information, and the comparing the behavioral information of any one or more of Examples 1-9 optionally includes comparing the second behavioral interaction information with the behavioral model associated with the user.

In Example 11, the method of any one or more of Examples 1-10 optionally includes updating the behavioral model associated with user account using the second behavioral information.

In Example 12, the adjusting an authentication confidence metric using the comparison of any one or more of Examples 1-11 optionally includes adjusting a confidence metric associated with the user account using the comparison.

In Example 13, the adjusting an authentication confidence metric using the comparison of any one or more of Examples 1-12 optionally includes adjusting a confidence metric associated with a group of user accounts using the comparison, wherein the group of user accounts includes the user account.

In Example 14, a system for providing persistent authentication monitoring of a user account of a physical, virtual, or networked computer system after the user account has authenticated access to the physical, virtual, or networked computer system via a login activity can include a server module configured to manage and analyze behavioral interaction model information associated with one or or more user accounts, wherein the one or more user accounts includes the user account, and a client module configured to periodically collect behavioral interaction information associated with the user account when the user account has authenticated access to the physical, virtual, or networked computer system. At least one of the server module or the client module can be configured to compare the behavioral interaction information with at least a portion of the behavioral interaction model information associated with the user account, and to adjust an authentication confidence metric, and to adjust an authentication confidence metric using the comparison of behavioral interaction information with the at least a portion of the behavioral interaction model information associated with the user account.

In Example 15, the behavioral interaction information of any one or more of Examples 1-14 optionally includes temporal, qualitative, and quantitative information associated with one or more user inputs to the physical, virtual, or networked computer system, wherein the one or more user inputs are associated with the user account.

In Example 16, the temporal, qualitative and quantitative information associated with one or more user inputs to the physical, virtual, or networked computer system of any one or more of Examples 1-15 optionally includes one or more keystrokes associated with the user account.

In Example 17, the temporal, qualitative, and quantitative information associated with one or more user inputs to the physical, virtual, or networked computer system of any one or more of Examples 1-16 optionally includes a pointing device input, a gesture sensing device, an accelerometer, an inertial sensor or an orientation sensor associated with the user account.

In Example 18, the behavioral interaction information of any one or more of Examples 1-17 optionally includes temporal, qualitative, and quantitative network traffic information associated with one or more user inputs to the physical, virtual, or networked computer system, wherein the one or more user inputs are associated with the user account.

In Example 19, at least one of the client module or the server module of any one or more of Examples 1-18 optionally is configured to provide an alert if the authentication confidence metric satisfies a threshold indicative of a security threat to the physical, virtual, or networked computer system.

In Example 20, the alert of any one or more of Examples 1-19 optionally includes revoking the authenticated access of the user account to the physical, virtual, or networked computer system.

In Example 21, at least one of the client module or the server module of any one or more of Examples 1-20 optionally is configured to determine the alert using the threshold and a system threat condition, wherein the system threat condition indicates a probability of a security breach of the physical, virtual, or networked computer system.

In Example 22, a computer readable medium comprising instructions that when executed by a processor execute a process that can include authenticating access for a user account to a physical, virtual, or networked computer system, collecting behavioral interaction information associated with the user account, comparing the behavioral interaction information with a behavioral model associated with the user account, and adjusting an authentication confidence metric using the comparison.

Example 23 can include, or can optionally be combined with any portion or combination of any portions of any one or more of Examples 1-22 to include, subject matter that can include means for performing any one or more of the functions of Examples 1-22, or a machine-readable medium including instructions that, when performed by a machine, cause the machine to perform any one or more of the functions of Examples 1-22.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A method for persistent authentication using biometric behavioral analyses, the method comprising:
authenticating access for a user account to a computer system;
collecting behavioral interaction information associated with the user account;
comparing the behavioral interaction information with a behavioral model associated with the user account; and
adjusting an authentication confidence metric using the comparison.

2. The method of claim 1, wherein the collecting behavioral interaction information includes collecting temporal, qualitative and quantitative information associated with one or more user inputs to the computer system.

3. The method of claim 2, wherein collecting temporal, qualitative and quantitative information associated with one or more user inputs to the computer system includes receiving one or more keystrokes at the physical, virtual, or networked computer system.

4. The method of claim 2, wherein collecting temporal, qualitative and quantitative information associated with one or more user inputs to the computer system includes receiving signals from a pointing device.

5. The method of claim 2 wherein collecting behavioral interaction information includes collecting temporal, qualitative, and quantitative user interaction information associated with interactions between the user and an application configured to operate on the computer system.

6. The method of claim 1, wherein collecting behavioral interaction information includes collecting temporal, qualitative, and quantitative network traffic information associated with one or more user inputs to the computer system.

7. The method of claim 1, including providing an alert if the authentication confidence metric satisfies a threshold.

8. The method of claim 7, wherein providing an alert includes restricting access to the computer system via the user account.

9. The method of claim 1, wherein collecting behavioral interaction information includes:
collecting first behavioral interaction information associated with the user account; and
generating the behavioral model associated with the user account using the first behavioral interaction information.

10. The method of claim 9, wherein collecting behavioral interaction information includes collecting second behavioral interaction information associated with the user account different from the first behavioral interaction information, and
wherein comparing the behavioral information includes comparing the second behavioral interaction information with the behavioral model associated with the user.

11. The method of claim 10, including updating the behavioral model associated with user account using the second behavioral information.

12. The method of claim 1, wherein adjusting an authentication confidence metric using the comparison includes adjusting a confidence metric associated with the user account using the comparison.

13. The method of claim 1, wherein adjusting an authentication confidence metric using the comparison includes adjusting a confidence metric associated with a group of user accounts using the comparison, wherein the group of user accounts includes the user account.

14. A system for providing persistent authentication monitoring of a user account of a computer system after the user account has authenticated access to the computer system via a login activity, the system comprising:
a server module configured to manage and analyze behavioral interaction model information associated with one or or more user accounts, wherein the one or more user accounts includes the user account; and
a client module configured to periodically collect behavioral interaction information associated with the user account when the user account has authenticated access to the computer system; and
wherein at least one of the server module or the client module is configured to compare the behavioral interaction information with at least a portion of the behavioral interaction model information associated with the user account, and to adjust an authentication confidence metric, and to adjust an authentication confidence metric using the comparison of behavioral interaction information with the at least a portion of the behavioral interaction model information associated with the user account.

15. The system of claim 14, wherein the behavioral interaction information includes temporal, qualitative, and quantitative information associated with one or more user inputs to the computer system, wherein the one or more user inputs are associated with the user account.

16. The system of claim 15, wherein the temporal, qualitative and quantitative information associated with one or more user inputs to the computer system includes one or more keystrokes associated with the user account.

17. The method of claim 15, wherein the temporal, qualitative, and quantitative information associated with one or more user inputs to the physical computer system includes a pointing device input associated with the user account.

18. The system of claim 14, wherein the behavioral interaction information includes temporal, qualitative, and quantitative network traffic information associated with one or more user inputs to the computer system, wherein the one or more user inputs are associated with the user account.

19. The system of claim 14, wherein at least one of the client module or the server module is configured to provide an alert if the authentication confidence metric satisfies a threshold indicative of a security threat to the computer system.

20. The system of claim 19, wherein the alert includes revoking the authenticated access of the user account to the computer system.

21. The system of claim 19, wherein at least one of the client module or the server module is configured to determine the alert using the threshold and a system threat condition, wherein the system threat condition indicates a probability of a security breach of the computer system.

22. A computer readable medium comprising instructions that when executed by a processor execute a process comprising:
authenticating access for a user account to a computer system;
collecting behavioral interaction information associated with the user account;
comparing the behavioral interaction information with a behavioral model associated with the user account; and
adjusting an authentication confidence metric using the comparison.
